(19) United States
(12) Patent Application Publication
(10) Pub. No.: US 2015/0306704 A1
(43) Pub. Date: Oct. 29, 2015

(54) DEVICE FOR MANUFACTURING BREATHABLE FILM BY USING LASER AND METHOD FOR MANUFACTURING SAME

(71) Applicants: GWANGJU INSTITUTE OF SCIENCE AND TECHNOLOGY, Gwangju (KR); DAE RYUNG PACKAGING INDUSTRY CO., LTD., Gwangju (KR)

(72) Inventors: Ik Bu SOHN, Gwangju (KR); Young Chul NOH, Gwangju (KR); Young Jin CHOI, Gwangju (KR)

(21) Appl. No.: 14/352,556

(22) PCT Filed: Jul. 10, 2012
(86) PCT No.: PCT/KR2012/005467

§ 371 Date: May 9, 2014

(30) Foreign Application Priority Data
Nov. 9, 2011 (KR) 10-2011-0116684

(51) Int. Cl. B23K 26/36; B23K 26/30; B23K 26/06; B23K 26/40; B23K 26/067

(52) U.S. Cl. CPC B23K 26/367; B23K 26/4025; B23K 26/0676; B23K 26/0635; B23K 26/425

(57) ABSTRACT

Disclosed are a gas-penetration film which is fabricated by processing grooves by irradiating a pulsed laser beam onto a moving film, an apparatus of fabricating the same, and a method of fabricating the same. A method of fabricating a gas-penetration film which irradiates a pulsed laser beam onto a moving film to continuously process grooves, includes splitting the pulsed laser beam; irradiating split pulsed laser beams onto the moving film at a constant interval to process multi-grooves; and controlling a movement speed of the moving film so as to repeatedly process a groove, which is adjacent to the groove processed by the split pulsed laser beam, by the pulsed laser beam. Therefore, the groove processings are repeatedly performed on the same groove to increase a depth of the groove.

### CROSS-REFERENCE TO RELATED APPLICATIONS

This application claims priority to and the benefit of Korean Patent Application No. 10-2011-0116684 filed in the Korean Intellectual Property Office on Nov. 9, 2011, the entire contents of which are incorporated herein by reference.

### TECHNICAL FIELD

The present invention relates to a laser apparatus and a method of fabricating a gas-penetration film and more particularly, to a laser apparatus and a method of fabricating a gas-penetration film which processes grooves by irradiating a pulsed laser beam onto a moving film to be superposed.

### BACKGROUND ART

A gas-penetration film (breathable film) refers to a functional material which penetrates air but does not penetrate liquid to improve storability and functionality of a packaging target. Due to a characteristic of the gas-penetration film, the gas-penetration film is widely used as a functional packaging material for maintaining freshness of hygiene products such as a diaper or a sanitary pad, agricultural products, and fermented foods.

However, the characteristic of the gas-penetration film is caused by a plurality of microgrooves and the plurality of microgrooves is formed by a process using various lasers. A pulsed laser beam is irradiated at a high speed to form microgrooves on the film without passing through the film so that the penetration of the liquid is blocked and a penetration of the air is increased.

An air permeability of the film is determined depending on a size, a depth, and a number of microgrooves which are formed on the film and thus a functionality of a product which uses the film as a material is determined.

That is, if the number of grooves is increased or a depth of the groove is large, the air permeability of the film is increased. However, if the number of grooves is increased, a film manufacturing device is configured to be complex and a processing time is increased. If one time pulse which is generated from the pulsed laser beam is used to process the groove, even though energy of the pulsed laser beam is high, the depth of the groove is not increased more than a predetermined depth of the groove.

### SUMMARY OF THE INVENTION

Embodiments of the present invention provide a laser apparatus and a method of fabricating a gas-penetration film which may increase a depth of a groove while reducing the number of grooves which are formed on the gas-penetration film using a simple fabricating method or manufacturing apparatus.

Furthermore, embodiments of the present invention provide a simplified laser apparatus and method of fabricating a gas-penetration film with a reduced time to process a groove.

An embodiment of the present invention provides a method of fabricating a gas-penetration film which irradiates a pulsed laser beam onto a moving film to continuously process grooves, the method including: splitting the pulsed laser beam; irradiating split pulsed laser beams onto the moving film at a constant interval to process multi-grooves; and controlling a movement speed of the moving film so as to repeatedly process a groove, which is adjacent to the groove processed by the split pulsed laser beam, by the pulsed laser beam.

The movement speed of the moving film may be controlled so that a time when the adjacent groove is disposed on an irradiating path of the split pulsed laser beam matches a time when a pulse of the split pulsed laser beam is irradiated.

The pulsed laser beam may be a femtosecond laser beam or an ultraviolet laser beam.

A size and a depth of the groove may change depending on an intensity of an energy of the pulsed laser beam.

The depth of the groove may change depending on the number of repeated groove processings.

Another embodiment of the present invention provides a method of fabricating a gas-penetration film which irradiates a pulsed laser beam onto a moving film to continuously process grooves, the method including: causing the pulsed laser beam to be incident onto a diffractive optical element to split the pulsed laser beam; collecting the pulsed laser beams which are split through a lens unit and vertically irradiating the pulsed laser beam onto the moving film at a constant interval to process a groove; and moving the moving film so as to repeatedly process a groove which is adjacent to the groove processed by the split pulsed laser beam, by the pulsed laser beam.

The moving film may move so that a time when the adjacent groove is disposed on an irradiating path of the split pulsed laser beam matches a time when a pulse of the split pulsed laser beam is irradiated.

The pulsed laser beam may be a femtosecond laser beam or an ultraviolet laser beam.

A size and a depth of the groove may change depending on an intensity of an energy of the pulsed laser beam.

The depth of the groove may change depending on the number of repeated groove processings.

A tension of the moving film may be controlled in order to prevent the moving film from loosening.

The method may further include detecting a position of an edge of the moving film.

Yet another embodiment of the present invention provides a laser apparatus of fabricating a gas-penetration film which irradiates a pulsed laser beam onto a moving film to form continuous grooves, the apparatus including: a diffractive optical element which splits incident pulsed laser beam as many as the maximum number of groove processings for the same groove; a lens unit which collects the split pulsed laser beam to vertically irradiate the pulsed laser beam onto the moving film at a constant interval; and a controller which controls a movement speed of the moving film so as to repeatedly process a groove which is adjacent to the groove processed by the split pulsed laser beam, by the pulsed laser beam.

The controller may control the movement speed of the moving film so that a time when the adjacent groove is disposed on an irradiating path of the split pulsed laser beam matches a time when a pulse of the split pulsed laser beam is irradiated.

The pulsed laser beam may be a femtosecond laser beam or an ultraviolet laser beam.

A size and a depth of the groove may change depending on an intensity of an energy of the pulsed laser beam.

The depth of the groove may change depending on the number of repeated groove processings.

The apparatus may further include a tension controller which controls a tension of the moving film in order to prevent the moving film from loosening.

The apparatus may further include a position controller which detects the position of the edge of the moving film to control a position of the moving film.

Still another embodiment of the present invention provides a method of fabricating a gas-penetration film which irradiates a pulsed laser beam onto a moving film to process continuous grooves, the method including: tracking a groove which is formed and moves at a starting point of a groove processing to change a path of the pulsed laser beam so as to irradiate a pulse onto the groove as many as a target number of pulses.

When the pulses are irradiated onto the groove as many as the target number of pulses, the path of the pulsed laser beam may be changed to the starting point of the groove processing.

According to the apparatus and the method of fabricating a gas-penetration film according to an embodiment of the present invention, a moving speed of the film and a pulse irradiating time of the split pulsed laser beam are synchronized such that the pulsed laser beam is split by a diffractive optical element (DOE) and grooves which are formed by the split pulsed laser beams are shifted to be repeatedly processed by a predetermined split pulsed laser beam. Therefore, the groove processings are repeatedly performed on the same groove to increase a depth of the groove.

According to the apparatus and the method of fabricating a gas-penetration film according to an embodiment of the present invention, the pulse superposition groove processing is performed onto the moving film so that a film processing time may be reduced.

According to the apparatus and the method of fabricating a gas-penetration film according to an embodiment of the present invention, a diffractive optical element, a moving speed of the film, and an energy of the pulsed laser beam are adjusted to adjust the number, the size, and the depth of the grooves so that an air permeability of the gas-penetration film may be easily adjusted.

The foregoing summary is illustrative only and is not intended to be in any way limiting. In addition to the illustrative aspects, embodiments, and features described above, further aspects, embodiments, and features will become apparent by reference to the drawings and the following detailed description.

### BRIEF DESCRIPTION OF THE DRAWINGS

FIG. 1 is a conceptual diagram illustrating an apparatus of fabricating a gas-penetration film according to a first embodiment of the present invention.

FIG. 2 is a conceptual diagram illustrating a method of fabricating a gas-penetration film according to a first embodiment of the present invention.

FIG. 3 is a graph illustrating a size and a depth of a groove in accordance with the number of superposition of pulses which are irradiated onto the groove.

FIG. 4 is an operation status diagram illustrating a status where a groove processing is performed on a film by a first pulse of the split pulsed laser beams at first time.

FIG. 5 is an operation status diagram illustrating a status where a groove is repeatedly processed on a moving film by a second pulse of pulsed laser beams which are split in the status of FIG. 4.

FIG. 6 is an operation status diagram illustrating a status where a groove is repeatedly processed on a moving film by a third pulse of pulsed laser beams which are split in the status of FIG. 5.

FIG. 7 is an operation status diagram illustrating a status where a groove is repeatedly processed on a moving film by a fourth pulse of pulsed laser beams which are split in the status of FIG. 6.

FIG. 8 is an operation status diagram illustrating a status where a groove is repeatedly processed on a moving film by a fifth pulse of pulsed laser beams which are split in the status of FIG. 7.

FIG. 9 is an operation status diagram illustrating a status where a groove is repeatedly processed on a moving film by an n-th pulse of pulsed laser beams which are split in the status of FIG. 8.

FIG. 10 is a graph illustrating an oxygen permeability in accordance with the number of superposition of pulses which are irradiated onto the groove.

FIG. 11 is a conceptual diagram illustrating a gas-penetration film fabricating method according to a second embodiment of the present invention.

FIG. 12 is an operation status diagram illustrating an operation status of the second embodiment which traces a moving groove to process a groove.

FIG. 13 is an operation status diagram illustrating an operation status of the second embodiment which starts a new groove processing at a starting point.

It should be understood that the appended drawings are not necessarily to scale, presenting a somewhat simplified representation of various features illustrative of the basic principles of the invention. The specific design features of the present invention as disclosed herein, including, for example, specific dimensions, orientations, locations, and shapes will be determined in part by the particular intended application and use environment.

In the figures, reference numbers refer to the same or equivalent parts of the present invention throughout the several figures of the drawing.

### DETAILED DESCRIPTION

Hereinafter, a laser apparatus and a method of fabricating a gas-penetration film according to an embodiment of the present invention will be described.

Advantages and characteristics of the present invention, and a method of achieving the advantages and characteristics will be clear by referring to embodiments described below in detail together with the accompanying drawings.

However, the present invention is not limited to embodiment disclosed herein but will be implemented in various forms. The embodiments are provided by way of example only, so that a person having ordinary skill in the art can fully understand the disclosures of the present invention and the scope of the present invention. Therefore, the present invention will be defined only by the scope of the appended claims.

In the description of the embodiment of the present invention, if it is considered that description of a related known technology may cloud the gist of the present invention, the detailed description thereof will be omitted.

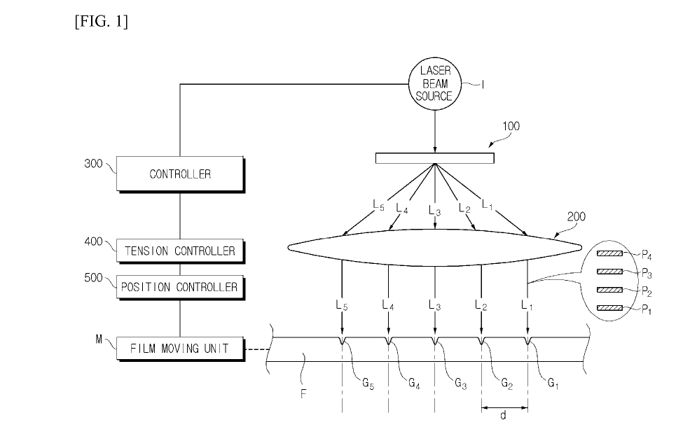

FIG. 1 is a conceptual diagram illustrating a laser apparatus of fabricating a gas-penetration film according to a first embodiment of the present invention.

A laser beam source L which is used in a laser apparatus of fabricating a gas-penetration film according to a first embodiment of the present invention and a method of fabricating the same generates an ultraviolet pulsed laser beam and the generated pulsed laser beam may have a wavelength of 355 nm, a pulse repetition rate of 20 kHz, a pulse duration of 25 ns, and an average power of 2 W.

As described above, in the case of a pulsed laser beam having a short pulse duration, energy is transmitted to an electron in an object by an interaction between the pulsed laser beam and a medium during a short time to break an atomic lattice. In this case, the object is not melted by heat but is decomposed for approximately one femtosecond (10⁻¹⁵ seconds) when an atom absorbs a photon and the object is erupted in a second to be processed, which is referred to as “ablation”.

Therefore, the processing using an ultra short pulsed laser beam is finished before the heat is transmitted to surroundings so that damage or structural change of the surrounding of the processed portion is not caused.

Prior to description of the laser apparatus of fabricating a gas-penetration film according to the embodiment of the present invention and a method of fabricating the same, a general structure and method of fabricating a gas-penetration film by generating the pulsed laser beam as described above will be described in brief.

A laser apparatus of fabricating a gas-penetration film includes a laser beam source L which generates a pulsed laser beam and a film moving unit M which moves the film. Various types of transferring units or distributing units which create a path of the pulsed laser beam in order to transmit the pulsed laser beam generated in the laser beam source L to the moving film may be configured between the laser beam source L and the film.

The film moving unit M is a means for moving a film at a constant speed and is formed by combining a roller assembly which is in contact with the film with friction, a motor which applies a rotatory force to the roller assembly, and power transmitting means.

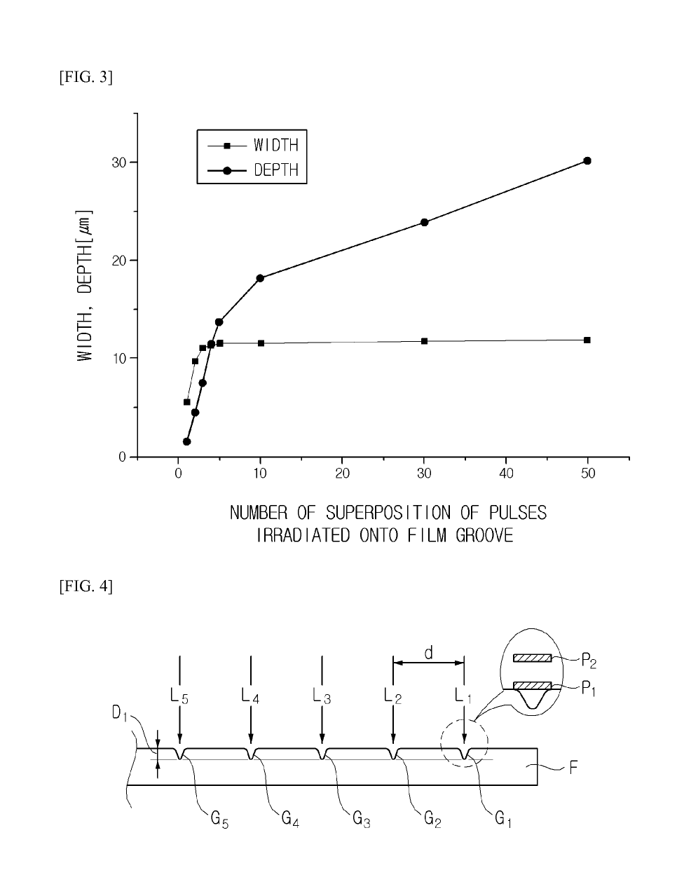

Here, the pulsed laser beam generates predetermined pulses per second and if the pulsed laser beam is continuously irradiated onto a film which is moving, microgrooves which are spaced apart from each other at regular intervals by an interval of the pulse and the movement of the film are formed. Such a width and a depth of the microgroove are affected by energy of the pulsed laser beam but when the groove of the film is formed by a single pulse irradiation, as described above, the depth of the groove is not increased any more at any instant even though the energy of the pulsed laser beam is increased. However, it is understood in advance through a graph of FIG. 3, which will be described below that a size and the depth of the groove are increased as the number of superposition of pulses which are irradiated onto the same groove is increased.

It is defined in advance that it is difficult to fabricate a film having a high air permeability through a groove with a small depth so that the embodiment of the present invention is configured to irradiate a pulse of the pulsed laser beam onto the same groove so as to be superposed in order to increase a depth of the groove which is formed on the film.

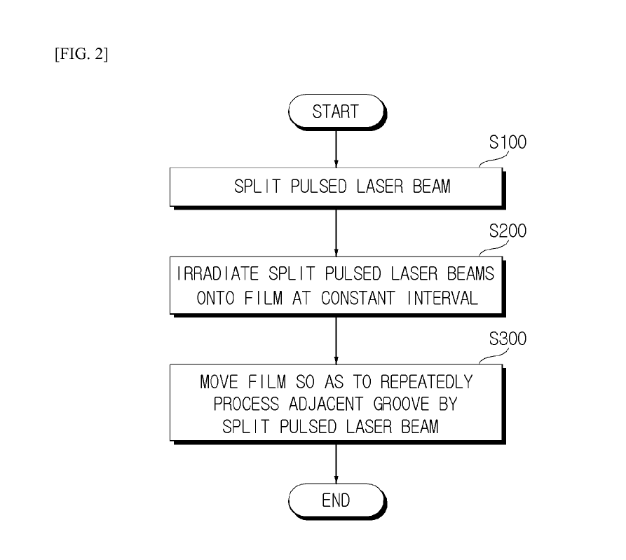

Hereinafter, a method of fabricating a gas-penetration film according to a first embodiment of the present invention will be described with reference to FIG. 2.

FIG. 2 is a conceptual diagram illustrating a method of fabricating a gas-penetration film according to a first embodiment of the present invention.

As illustrated in FIGS. 1 and 2, first, a pulsed laser beam is split in step S100.

An ultraviolet pulsed laser beam having a characteristic described above which is generated in a laser beam source L is split by a diffractive optical element (DOE) 100. Here, the diffractive optical element (DOE) is an optical element which uses diffraction phenomena of light and has advantages such as reduction in size, reduction in weight, and mass production of a product.

Such a diffractive optical element (DOE) 100 splits the pulsed laser beam in the form of matrix but microgrooves only in a longitudinal direction are illustrated in FIGS. 1 and 2, for convenience of description of the embodiment.

The maximum number of superposition of pulses which are irradiated onto the same groove is determined as many as the number (5 in FIG. 1) of the pulsed laser beams L1, L2, L3, L4, and L5 which are split by the diffractive optical element (DOE) 100. Therefore, the number of split pulsed laser beams is determined in consideration of an air permeability of the film to be fabricated and the characteristic of the diffractive optical element (DOE) 100 is selected therefor.

The split pulsed laser beams L1, L2, L3, L4, and L5 periodically generate pulses denoted by P1, P2, P3, and P4 in FIG. 1. Here, for the convenience of description, P1 indicates a first pulse of the split pulsed laser beam, P2 indicates a second pulse, P3 indicates a third pulse, and P4 indicates a fourth pulse.

Next, the pulsed laser beams L1, L2, L3, L4, and L5 which are split in the previous step S100 are vertically irradiated onto a film F at a constant interval to form a plurality of grooves G1, G2, G3, G4, and G5 onto the film F in step S200.

The pulsed laser beams L1, L2, L3, L4, and L5 which are split into a plurality of pulsed laser beams by the diffractive optical element (DOE) 100 are guided by a lens unit (telecentric lens) 200 so as to be vertically incident onto a surface of the film F in order to maintain the same processing focus.

FIG. 3 is a graph illustrating a size and a depth of a groove in accordance with the number of superposition of pulses which are irradiated onto the groove and FIG. 4 is an operation status diagram illustrating a status where a groove forming is performed on a film by a first pulse of the split pulsed laser beams at first time.

As illustrated in FIGS. 1 and 4, initial five grooves G1, G2, G3, G4, and G5 are formed on the film F by the split pulsed laser beams L1, L2, L3, L4, and L5. The five grooves G1, G2, G3, G4, and G5 are formed by a first pulse P1 of the split pulsed laser beams L1, L2, L3, L4, and L5.

Depths of the grooves G1, G2, G3, G4, and G5 formed by the first pulse P1 are D1 and uniform.

Next, the film F moves to repeatedly form a groove G2 which is adjacent to the groove G1 formed by the split pulsed laser beam (for example, if it is assumed as L1) by the split pulsed laser beam L1 in step S300.

As can be seen from FIG. 3, the depth of the groove is increased in proportion to the number of superposition of pulses which are irradiated onto the same groove. Therefore, in order to increase an air permeability of the film by increasing the depth of the groove while reducing the processing time by reducing the number of grooves which are formed on the film F, the initially formed grooves G1, G2, G3, G4, and G5 are repeatedly formed by the pulsed laser beams L1, L2, L3, L4, and L5 which are sequentially split during the movement of the film F.

In the meantime, it is confirmed through FIG. 3 that the width of the groove is not increased when the number of superposition of pulses which are irradiated on the same groove is a predetermined number or higher.

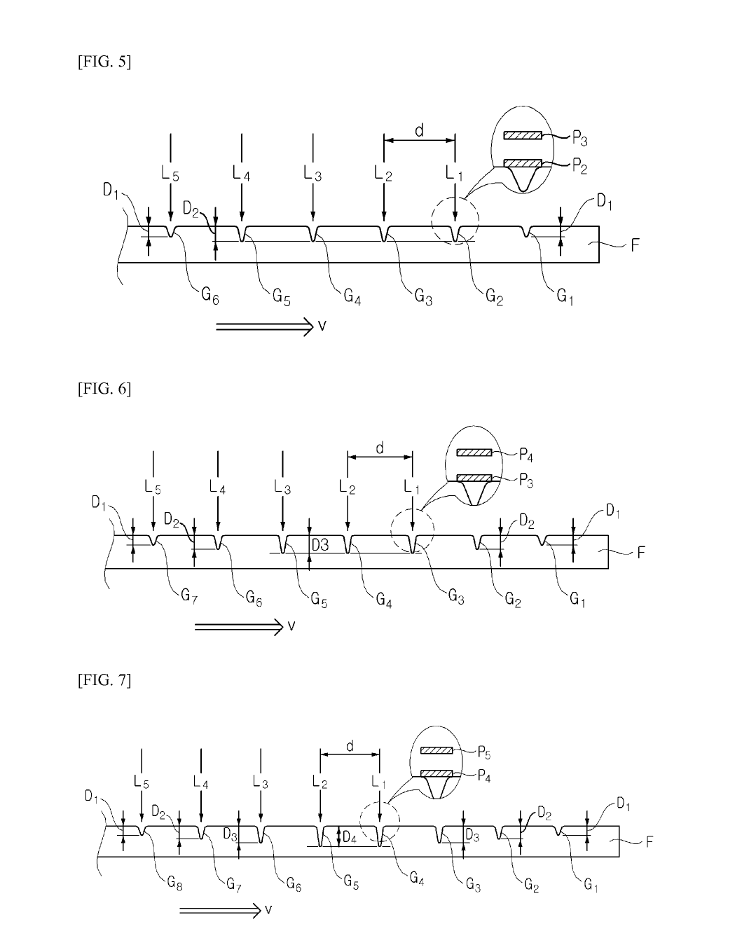

Hereinafter, a process of repeatedly forming the grooves G1, G2, G3, G4, and G5 which are formed on the film F will be described with reference to FIGS. 5 to 9.

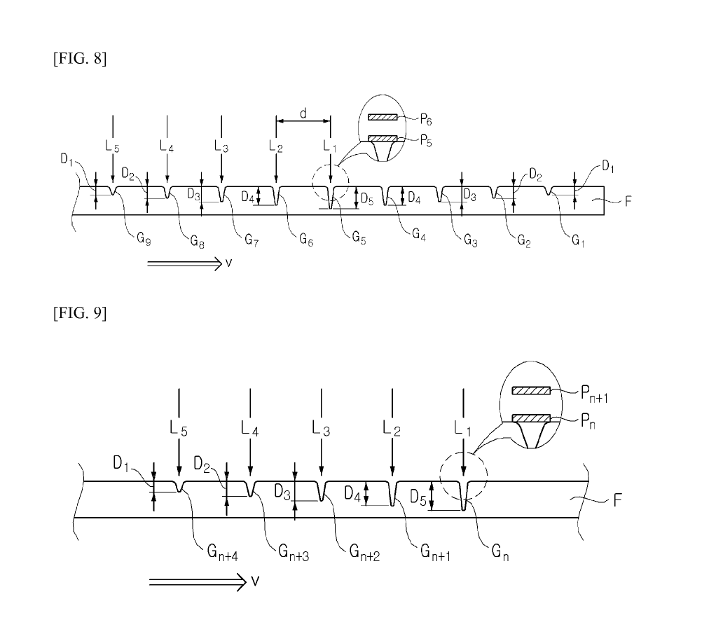

FIG. 5 is an operation status diagram illustrating a status where a groove is repeatedly formed on a moving film by a second pulse of pulsed laser beams which are split in the status of FIG. 4, FIG. 6 is an operation status diagram illustrating a status where a groove is repeatedly formed on a moving film by a third pulse of pulsed laser beams which are split in the status of FIG. 5, FIG. 7 is an operation status diagram illustrating a status where a groove is repeatedly formed on a moving film by a fourth pulse of pulsed laser beams which are split in the status of FIG. 6, and FIG. 8 is an operation status diagram illustrating a status where a groove is repeatedly formed on a moving film by a fifth pulse of pulsed laser beams which are split in the status of FIG. 7. Hereinafter, the split pulsed laser beams are denoted by L1, L2, L3, L4, and L5. The intervals of the pulsed laser beams L1, L2, L3, L4, and L5 are uniform and denoted by d in FIGS. 4 to 8.

As illustrated in FIG. 5, when the film F moves at a constant speed V, an adjacent groove G2 is disposed on a path of the pulsed laser beam L1 so that the adjacent groove G2 is repeatedly processed by a second pulse P2 of the pulsed laser beam L1. Therefore, the number of superposition of pulses which are irradiated onto the adjacent groove G2 is increased to be two and the depth is also increased from D1 to D2.

Here, the constant speed V of the film F means a movement speed of the film F at which a time when the adjacent groove G2 is disposed on the path of the pulsed laser beam L1 by moving the intervals d of the split pulsed laser beams L1, L2, L3, L4, and L5 matches a time when a second pulse P2 which is next to the first pulse P1 of the pulsed laser beam L1 which forms the groove G1 reaches a surface of the film F.

To this end, a process of synchronizing the distance d of the split pulsed laser beams L1, L2, L3, L4, and L5, a pulse repetition rate (Hz) of the split pulsed laser beams L1, L2, L3, L4, and L5, and a film moving speed V is required.

The moving speed of the film F is adjusted by a controller 300 which controls the film moving unit M which will be described below.

By the process as described above, the grooves G2, G3, G4, and G5 of FIG. 5 are repeatedly irradiated by the second pulse P2 of the split pulsed laser beams L1, L2, L3, and L4 so that the depth thereof is increased to be D2.

A groove G6 of FIG. 5 is newly formed by the pulsed laser beam L5. The groove G6 of FIG. 5 is newly processed by a second pulse P2 of the pulsed laser beam L5.

Hereinafter, as illustrated in FIG. 6, when the film F continuously moves at a constant speed V and an adjacent groove G3 is disposed on a path of the pulsed laser beam L1, the adjacent groove G3 is repeatedly irradiated by a third pulse P3 of the pulsed laser beam L1 which reaches the surface of the film F. Therefore, the number of superposition of pulses which are irradiated onto the adjacent groove G3 is increased to be three and the depth is also increased from D2 to D3.

By the process as described above, the grooves G4 and G5 of FIG. 6 are repeatedly processed by the third pulse P3 of the split pulsed laser beams L2 and L3 so that the depth thereof is increased to be D3.

A groove G7 of FIG. 6 is newly processed by the pulsed laser beam L5. The groove G7 of FIG. 6 is newly processed by the third pulse P3 of the pulsed laser beam L5 and the groove G6 of FIG. 6 is repeatedly processed by the third pulse P3 of the pulsed laser beam L4. The number of superposition of pulses which are irradiated onto the groove G6 is increased to be two and the depth is also increased from D1 to D2.

The grooves G1 and G2 of FIG. 6 which are out of the paths of the split pulsed laser beams L1, L2, L3, L4, and L5 have been completely processed.

Hereinafter, as illustrated in FIG. 7, when the film continuously moves at a constant speed V and the adjacent groove G4 is disposed on a path of the pulsed laser beam L1, an adjacent groove G4 is repeatedly processed by a fourth pulse P4 of the pulsed laser beam L1 which reaches the surface of the film F. Therefore, the number of superposition of pulses which are irradiated onto the adjacent groove G4 is increased to be four and the depth is also increased from D3 to D4.

By the process as described above, the groove G5 of FIG. 7 is also repeatedly processed by the fourth pulse P4 of the split pulsed laser beam L2 so that the depth is increased to be D4.

A groove G8 of FIG. 7 is newly formed by the pulsed laser beam L5. The groove G8 of FIG. 7 is newly processed by the fourth pulse P4 of the pulsed laser beam L5 and the groove G7 of FIG. 7 is repeatedly processed by the fourth pulse P4 of the pulsed laser beam L4. The number of superposition of pulses which are irradiated onto the groove G7 is increased to be two and the depth is also increased from D1 to D2. The groove G6 of FIG. 7 is repeatedly processed by the fourth pulse P4 of the pulsed laser beam L3. The number of superposition of pulses which are irradiated onto the groove G6 is increased to be three and the depth is also increased from D2 to D3.

Hereinafter, as illustrated in FIG. 8, the film continuously moves at a constant speed V and the adjacent groove G5 is disposed on a path of the pulsed laser beam L1 so that an adjacent groove G5 is repeatedly processed by a fifth pulse P5 of the pulsed laser beam L1. Therefore, the number of superposition of pulses which are irradiated onto the adjacent groove G5 is increased to be five and the depth is also increased from D4 to D5.

The number of pulses which are irradiated onto the grooves G6, G7, G8, and G9 of FIG. 8 by the fifth pulses P5 of the pulsed laser beams L2, L3, L4, and L5 is accumulated.

FIG. 9 is an operation status diagram illustrating a status where a groove is repeatedly processed on a moving film by an n-th pulse of pulsed laser beams which are split in the status of FIG. 8.

Hereinafter, as illustrated in FIG. 9, while the film F moves at a constant speed V, an initial groove is processed in the pulsed laser beam L5 and a process of accumulating and irradiating two pulses in the pulsed laser beam L4, accumulating and irradiating three pulses in the pulsed laser beam L3, accumulating and irradiating four pulses in the pulsed laser beam L2, and accumulating and irradiating five pulses in the pulsed laser beam L1 is performed.

Therefore, the maximum number of superposition of irradiated pulses which are irradiated onto the grooves Gn, Gn+1, Gn+2, Gn+3, and Gn+4 is five, which matches the number of split pulsed laser beams by the diffractive optical element (DOE) 100.

Therefore, a desired number of split pulsed laser beams is adjusted by selecting an appropriate diffractive optical element (DOE) 100 in accordance with a depth of a groove to be embodied on the film F.

As described above, in order to exactly repeatedly process the same groove by irradiating a laser beam pulse to be superposed to process a groove on a film, it is important to uniformly move the film F at a constant speed V and maintain a constancy of the position of the film.

To this end, as illustrated in FIG. 1, a position controller 500 which corrects a deviation of a right and a left of the moving film F may be provided. Even though not illustrated in the drawing, the position controller 500 may be configured by combining sensors which detect an edge of the moving film and driving means which adjust a displacement of a roller which moves the film F to correct the deviation of the right and the left of the film F based on position information of the detected film.

In order to prevent the film F from deviating from a focal distance of the pulsed laser beam due to the loosening of the film, a tension controller 400 which adjusts a tension of the film F may be provided. Even though not illustrated in the drawing, the tension controller 400 may be configured by combining sensors which detect a loosened position of the film F and control units which control a rotation speed of the rollers which move the film F so as to correct the loosening of the film F based on the position information of the detected film.

Rotated displacement measuring sensors such as an encoder are provided in the film moving unit M to measure the speed of the film M and detect a speed variation of the film F, thereby controlling the rotation speed of the roller in a movement speed variation section of the film F.

The controller 300 of FIG. 1 adjusts the energy of the pulsed laser beam and the movement speed of the film F to adjust the number of grooves, the width and the depth of the groove and thus adjust an air permeability of the film F to be processed.

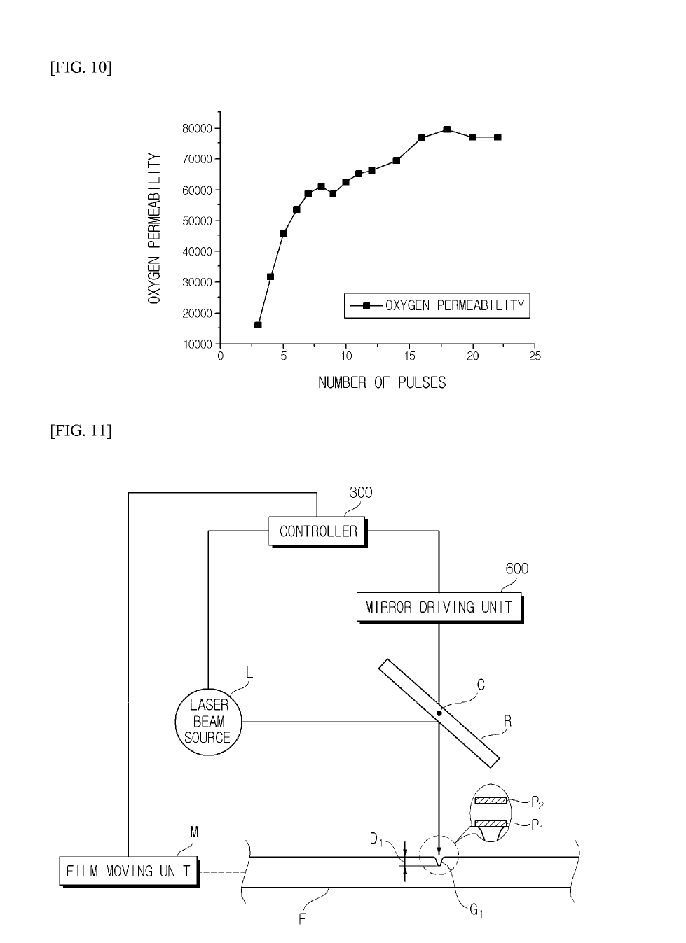

FIG. 10 is a graph illustrating an oxygen permeability in accordance with the number of superposition of pulses which are irradiated onto the groove.

As illustrated in FIG. 10, it is confirmed that as the number of superposition of pulses which are irradiated onto the same groove at constant laser beam pulse energy is increased, the oxygen permeability of the film F is increased.

Hereinafter, a gas-penetration film according to a second embodiment of the present invention, an apparatus of fabricating the same, and a method of fabricating the same will be described with reference to FIGS. 11 to 13.

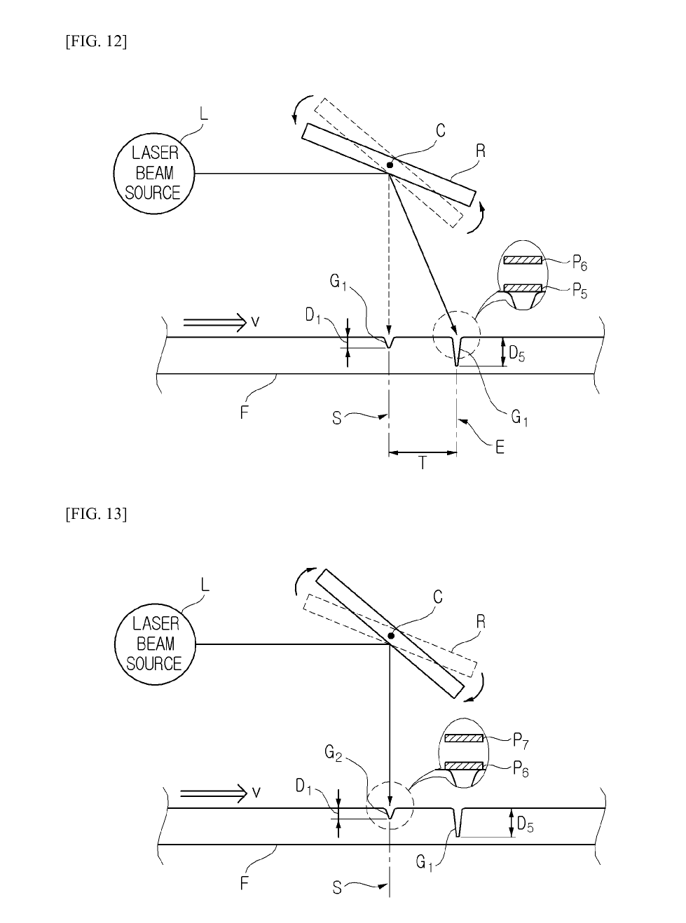

FIG. 11 is a conceptual diagram illustrating a method of fabricating a gas-penetration film according to a second embodiment of the present invention, FIG. 12 is an operation status diagram illustrating an operation status of the second embodiment which traces a moving groove to process a groove, and FIG. 13 is an operation status diagram illustrating an operation status of the second embodiment which starts a new groove processing at a starting point.

As illustrated in FIG. 11, another embodiment which repeatedly irradiates a pulse of a pulsed laser beam onto the same groove is configured to change a path of the pulsed laser beam which is incident from a laser beam light source L in accordance with a movement direction of a groove G1 to irradiate the pulse to be superposed as many as a target number of pulses while tracking the same groove G1 which is moving.

An apparatus according to a second embodiment of the present invention, as illustrated in FIG. 11, includes a mirror R which switches a path of an incident pulsed laser beam to irradiate the pulsed laser beam onto the film F and the mirror R rotates around a rotary shaft C. A mirror driving unit 600 which applies a rotatory force to the mirror R is provided.

As illustrated in FIGS. 11 and 12, a first groove G1 is formed by a first pulse P1 of a pulsed laser beam at a starting point (S in FIG. 12) of the groove processing. When the film F moves at a predetermined speed V, the groove G1 also moves and the mirror R rotates in a counter clockwise direction so as to change the path of the pulsed laser beam by tracking the moving groove G1.

If it is assumed that E of FIG. 12 is an ending point of the groove processing on the groove G1, the pulses are accumulated as many as the target number of pulses and irradiated in the groove processing section (T of FIG. 12). In FIG. 12, the target number of pulses is five and the groove is processed by five pulses while the groove G1 moves in the groove processing section (T of FIG. 12). Therefore, a depth of the groove G1 is increased from D1 at the starting point S to D5 at the ending point.

When the superposed pulses are irradiated onto the groove G1 as many as the target number of pulses, a controller 300 controls the mirror driving unit 600 to rotate the mirror R in a clockwise direction so that the path of the pulsed laser beam is disposed at the starting point S as illustrated in FIG. 13.

Thereafter, a second groove G2 starts to be formed by a sixth pulse P6 of the pulsed laser beam so that the groove processing which is similar to the first groove G1 is performed on the second groove G2.

The controller 300 controls the mirror driving unit 600 and the film moving unit M so as to irradiate the pulse to be superposed in the same groove as many as the target number of pulses in the groove processing section (T of FIG. 12) and adjusts a rotation dislocation and a rotation speed of the mirror R, and a movement speed of the film. Intervals between grooves are determined in proportion to a length of the groove processing section (T of FIG. 12).

In the meantime, even though the second embodiment illustrated in FIGS. 11 to 13 is configured to switch the path of the pulsed laser beam to track the same groove which is moving through a rotating mirror M, the invention is not limited thereto and even though not illustrated in the drawing, may be configured such that the laser beam light source L directly rotates to track the same groove which is moving. In this case, a separate driving unit which rotates the laser beam light source L is provided and the laser beam light source L is provided so as to directly irradiate a pulsed laser beam onto the moving film F.

A laser apparatus and a method of fabricating a gas-penetration film according to an embodiment have been described above.

As described above, the embodiments have been described and illustrated in the drawings and the specification. The embodiments were chosen and described in order to explain certain principles of the invention and their practical application, to thereby enable others skilled in the art to make and utilize various embodiments of the present invention, as well as various alternatives and modifications thereof. As is evident from the foregoing description, certain aspects of the present invention are not limited by the particular details of the examples illustrated herein, and it is therefore contemplated that other modifications and applications, or equivalents thereof, will occur to those skilled in the art. Many changes, modifications, variations and other uses and applications of the present construction will, however, become apparent to those skilled in the art after considering the specification and the accompanying drawings. All such changes, modifications, variations and other uses and applications which do not depart from the spirit and scope of the invention are deemed to be covered by the invention which is limited only by the claims which follow.

What is claimed is:

1. A method of fabricating a gas-penetration film which irradiates a pulsed laser beam onto a moving film to continuously process grooves, the method comprising:
splitting the pulsed laser beam;
irradiating split pulsed laser beams onto the moving film at a constant interval to process multi-grooves; and
controlling a movement speed of the moving film so as to repeatedly process a groove which is adjacent to the groove processed by the split pulsed laser beam, by the pulsed laser beam.

2. The method of claim 1, wherein the movement speed of the moving film is controlled so that a time when the adjacent groove is disposed on an irradiating path of the split pulsed laser beam matches a time when a pulse of the split pulsed laser beam is irradiated.

3. The method of claim 1, wherein the pulsed laser beam is a femtosecond laser beam or an ultraviolet laser beam.

4. The method of claim 1, wherein a size and a depth of the groove change depending on an intensity of an energy of the pulsed laser beam.

5. The method of claim 1, wherein a depth of the groove changes in accordance with the number of repeated groove processings.

6. A method of fabricating a gas-penetration film which irradiates a pulsed laser beam onto a moving film to continuously process grooves, the method comprising:
causing the pulsed laser beam to be incident onto a diffractive optical element to split the pulsed laser beam;
collecting the pulsed laser beams which are split through a lens unit and vertically irradiating the pulsed laser beam onto the moving film at a constant interval to process a groove; and
moving the moving film so as to repeatedly process a groove which is adjacent to the groove processed by the split pulsed laser beam, by the pulsed laser beam.

7. The method of claim 6, wherein the moving film is moved so that a time when the adjacent groove is disposed on an irradiating path of the split pulsed laser beam matches a time when a pulse of the split pulsed laser beam is irradiated.

8. The method of claim 6, wherein the pulsed laser beam is a femtosecond laser beam or an ultraviolet laser beam.

9. The method of claim 6, wherein a size and a depth of the groove change depending on an intensity of an energy of the pulsed laser beam.

10. The method of claim 6, wherein a depth of the groove changes in accordance with the number of repeated groove processings.

11. The method of claim 6, further comprising:
controlling a tension of the moving film in order to prevent the moving film from loosening.

12. The method of claim 6, further comprising:
detecting a position of an edge of the moving film.

13. An laser apparatus of fabricating a gas-penetration film which irradiates a pulsed laser beam onto a moving film to form continuous grooves, the apparatus comprising:
a diffractive optical element which splits an incident pulsed laser beam as many as the maximum number of groove processings which are repeatedly performed on the same groove;
a lens unit which collects the split pulsed laser beam to vertically irradiate the pulsed laser beam onto the moving film at a constant interval; and
a controller which controls a movement speed of the moving film so as to repeatedly process a groove which is adjacent to the groove processed by the split pulsed laser beam, by the pulsed laser beam.

14. The laser apparatus of claim 13, wherein the controller controls the movement speed of the moving film so that a time when the adjacent groove is disposed on an irradiating path of the split pulsed laser beam matches a time when a pulse of the split pulsed laser beam is irradiated.

15. The laser apparatus of claim 13, wherein the pulsed laser beam is a femtosecond laser beam or an ultraviolet laser beam.

16. The laser apparatus of claim 13, wherein a size and a depth of the groove change depending on an intensity of an energy of the pulsed laser beam.

17. The laser apparatus of claim 13, wherein a depth of the groove changes in accordance with the number of repeated groove processings.

18. The laser apparatus of claim 13, further comprising:
a tension controller which controls a tension of the moving film in order to prevent the moving film from loosening.

19. The laser apparatus of claim 13, further comprising:
a position controller which detects a position of an edge of the moving film to control a position of the moving film.

20. A method of fabricating a gas-penetration film which irradiates a pulsed laser beam onto a moving film to process continuous grooves, the method comprising:
tracking a groove which is formed and moves at a starting point of a groove processing to change a path of the pulsed laser beam so as to irradiate a pulse onto the groove to be superposed as many as a target number of pulses.

21. The method of claim 20, wherein when the pulses are irradiated onto the groove as many as the target number of pulses, the path of the pulsed laser beam is changed to the starting point of the groove processing.
